(19) United States
(12) Patent Application Publication
(10) Pub. No.: US 2013/0183653 A1
(43) Pub. Date: Jul. 18, 2013

(54) LEARNING ASSISTANT DEVICE AND METHOD

(71) Applicants: Manuchehr Sakinezhad, Esfahan (IR); Narges Naderi, Esfahan (IR)

(72) Inventors: Manuchehr Sakinezhad, Esfahan (IR); Narges Naderi, Esfahan (IR)

(21) Appl. No.: 13/348,647

(22) Filed: Jan. 12, 2012

(51) Int. Cl. G09B 25/00

(52) U.S. Cl. 434/368

(57) ABSTRACT

The various embodiments herein provide a method and device for assisting a learner for learning a subject matter. The device comprises an inner rotating cylinder provided with two co-axial and concentric cylinders of same altitude but with different diameters. An outer rotating cylinder having several port holes is adapted to embrace the inner rotating cylinder. Several vanes are provided between the two co-axial and concentric cylinders for creating several cells. The number of cells is equal to a number of days in a learning plan. The review papers containing several subject matters are placed in the cells. The number of portholes is equal to a number of review stages in the learning plan. The device enables the learner to review the subject matters by opening the portholes until the end of the learning plan is achieved.

### BACKGROUND

1. Technical Field

The embodiments herein generally relates to learning and teaching aid tools and particularly relate to a method of for making a learning aid tool. The embodiments herein more particularly relate to a learning aid tool which enables the users to learn and remember various subject matters.

2. Description of the Related Art

Substantially, learning refers to a set of procedures for storing information in the brain and retrieving them in the future. The procedure comprises acquiring, encoding, storing and retrieving the data from the brain. Most of the scientists, who have worked on memory, have defined the memory as two sets of memory such as a short term memory and a long term memory. At first, the brain stores the data immediately and temporarily in the sensory memory. Any of our senses has a specific procedure for storing a data in this sensory system. When an object is seen through the eyes, it is temporarily stored in the visual system. Even after closing the eyes, the object will be visible. When a sound is heard, the sound is heard even after hearing the sound. Hence our senses have a different procedure for storing the data temporarily, and they have distinct survival rates in the sensory system. This information is then transmitted to the working memory while we pay attention to the particular information registered in the sensory system.

The short term memory or working memory refers to the ability to access the information existing in the mind during a short time. It may also refer to the ability of sorting information and recording it in the long term memory. The data can permanently remain in the working memory on repeated use of the captured data. Once the repetition stops, the data is lost or forgotten.

Also the working memory has some space restrictions. Although the working memory can retain a large amount of information, the volume of the information would not seem to be too much in comparison to what human beings are ready to learn. The admitted researches in the learning field indicate that we can retain almost seven topics in the working memory. Also, the working memory plays a very significant role in the intellectual activities such as solving a problem in the mind.

The matters related to the learning and memory remains and returns to a long-term memory. Generally, the long-term memory refers to a system of brain, capable of storing and retaining a data persistently. There are various theories about the manner of data registration in the long term memory. One of the theories claims that at first, time information enters into the working memory after a time interval. The long term memory does not have any limitation and people are constantly learning new skills and information during the life time. A model of memory for understanding the performance of memory includes providing information into the brain, and storing the information in the sensory memory temporarily. If attention is paid to the information, then the information enters into the working memory and is usable. Finally, the information is transformed to the long term memory, through encoding techniques such as repetition and mental review.

Many inventions and plans have been proposed in the field of training and learning aids. These mainly fall in two categories such as boxes holding flashcards and software tools.

The boxes holding flashcards are generally in a rectangular shape, in which the learner is obliged to review the subject matters and move the flash cards in different days and times which are expressed based on the distinct learning theories and definite deadlines, transform them to the higher stages of review. The method leads to complex instructions, discouragement of learner and consequently resulting in reduction of efficiency thereby losing interest in the study. All of these points decrease a tendency towards using the instrument. A daily displacement of the subject matters, paying attention to each of them for determining the review of a deadline and then their manual displacement to higher stages of review are the factors that made the boxes holding the flashcards difficult and complex.

Due to a high complexity of the mentioned instruction in recalling the review times in the training aid boxes and also because of the main concern of the learner in considering a reminder of a review time in a peculiar manner to different subject matters that have been entered into the instrument by the learner, the confusion risk of different times is high. So many efforts have been taken to remove this problem by designing softwares aiding in learning, among which we can mention a Learner box. To use this kind of software, the learner enters the subject matter that need to be studied by the method of typing into the software, so the software would provide the learner with subject matters to review in systematic times. The method of software tool is not tangible for people, because the learner needs a standby system for even a simple word, while the learners usually tend to read the materials tangibly and concretely. The evident example of this is that of a digital book and hard copy of the book. The other shortcoming of a software tool is that the user has to type the materials and the typing of the many mathematical formulas are too hard as they have indices and signs and so the learner would not be able to write the formula on the flashcards easily. Also most of the time, people tend to review the materials in the rows or during a trip in the vehicle in the due time, the method demands the system to be turned on, which is too difficult for the learner.

At present there is no simple and tangible tool and method that can perform all the learning and revision principles. However, in the existing tools, the learner has to perform the learning and reviewing principles. Because of these principles, the main issue is the learner's involvement for performing the complicated instruction for implementing the principles, instead of learning, using and reviewing principles. This complexity makes the learner exhausted in the process of learning and reviewing and as a result distances the learner from the effects of principles of learning and finally leads to a lack of acceptance. In the existing tools, the learner has to recognize the date of reviewing an issue and when the person forgets to recognize the date, the issues of different days are mixed together thereby ruining all the work done by the learner.

Hence, there is a need for an intelligent educational device and method for recognizing the time to be devoted for learning each subject matter. There is also a need for a device and a method for reviewing the subject matter in correct time intervals thereby making a geometric progression to convey the subject matter from the short term memory to the long term memory. Further there is a need for the device and method to improve the learners tendency and attraction towards learning by avoiding the repetition and creating pleasure in learning and reviewing.

The abovementioned shortcomings, disadvantages and problems are addressed herein and which will be understood by reading and studying the following specification.

### OBJECTS OF THE EMBODIMENTS

The primary object of the embodiments herein is to provide a device and method for a learner for learning a subject matter in the shortest time with a long lasting impact.

Another object of the embodiments herein is to provide a device and method for aiding a revision of a subject matter.

Yet another object of the embodiments herein is to provide a device and method for transferring a plurality of the subject matters learnt from a short term memory to long term memory.

Yet another object of the embodiments herein is to provide a device and method for analyzing and remembering the plurality of the subject matters at the preset time intervals.

Yet another object of the embodiments herein is to provide a device and method for a better improvement of the memory capacity.

Yet another object of the embodiments herein is to provide a device and method for lowering a forgetting curve.

Yet another object of the embodiments herein is to provide a device and method for allotting the correct time intervals for the plurality of the subject matters to establish a balance.

Yet another object of the embodiments herein is to provide a device and method adapted to design a learning and revision program in a step by step manner to make a learning process more attractive.

Yet another object of the embodiments herein is to provide a simple and tangible device and a method for learning and revising the plurality of subject matters.

Yet another object of the embodiments herein is to provide a device and method to eliminate a need for the learner to track the date of last revision for a subject matter.

Yet another object of the embodiments herein is to provide a device and method for learning the plurality of subject matters for making the learner to show more tendencies towards implementing the plurality of subject matters.

Yet another object of the embodiments herein is to provide a device and method for increasing a performance of the learner in the process of learning.

Yet another object of the embodiments herein is to provide a device and method to transfer a subject matter to the working memory in an efficient manner.

Yet another object of the embodiments herein is to provide a device and method to prevent a memory loss by improving the memory capacity.

Yet another object of the embodiments herein is to provide a device and method for controlling the different aspects of attention and encoding operations in a memory for transforming the information to the long term memory through a simple procedure.

These and other objects and advantages of the embodiment herein will become readily apparent from the following summary and the detailed description taken in conjunction with the accompanying drawings.

### SUMMARY

The various embodiments herein provide a device for assisting a learner for learning a subject matter. According to an embodiment herein, the device comprises an inner rotating cylinder. The inner rotating cylinder further comprises at least two co-axial and concentric cylinders of same altitude and different diameter. The device further comprises an outer rotating cylinder adapted to embrace the inner rotating cylinder. A plurality of vanes are arranged between the two co-axially and concentrically arranged inner rotating cylinder and outer rotating cylinder for creating a plurality of cells equal to a number of days in a learning plan. A plurality of review papers containing a plurality of subject matters are placed in the plurality of cells and a plurality of portholes equal to a number of review stages in the learning plan are located on the outer rotating cylinder in parallel to the plurality of cells. The device enables the learner to review the plurality of subject matters by opening the plurality of portholes until the end of the learning plan for learning the plurality of subject matters is reached.

According to an embodiment herein, the device further comprises a gear system placed between the inner rotating cylinder and the outer rotating cylinder for dividing an entire peripheral surface of the outer rotating cylinder into a predetermined number of the plurality of cells in the inner rotating cylinder.

According to an embodiment herein, the gear system is a serrated gear adapted to get locked such that the outer rotating cylinder is rotatably moved along the inner rotating cylinder at a rate of one cell in a day.

According to an embodiment herein, a diameter of the outer rotating cylinder is more than a diameter of the inner rotating cylinder.

According to an embodiment herein, the number of days in the learning plan is at least 32.

According to an embodiment herein, the number of review stages among the plurality of days in the learning plan is at least 6.

According to an embodiment herein, each review stage is set at a distance making a geometric progression of 2 from a first review day to a last review day.

According to an embodiment herein, the bottom of the space between the two co-axial and concentric cylinders is covered to hold the plurality of review papers in place.

According to an embodiment herein, the dimensions of the plurality of portholes and the plurality of cells located are same.

According to an embodiment herein, the device further comprises a joining means for joining the inner rotating cylinder with the outer rotating cylinder at a joint axis point for the cylinders thereby making the inner rotating cylinder and the outer rotating cylinder to spin on each other.

According to an embodiment herein, a top surface of the outer rotating cylinder is covered.

According to an embodiment herein, the plurality of portholes is arranged in such a manner that the last porthole immediately precedes the first porthole.

According to an embodiment herein, the review paper is of a predetermined color for simulating a visual sense for transferring a subject matter into a working memory of the learner.

According to one embodiment herein, a method is provided for assisting a learner for learning a plurality of subject matters. The method comprising the steps of defining a learning plan having a pre-defined number of learning days and review stages, opening a plurality of portholes present on a outer rotating cylinder, placing a plurality of review papers containing the plurality of subject matters in a cell below the first porthole and reviewing the plurality of subject matters. The method enables the learner to learn the plurality of subject matters by reviewing a subject matter on the day defined in each review stage until the end of the learning plan.

According to an embodiment herein, the step of reviewing the plurality of subject matters further comprises turning the outer rotating cylinder along a cell in a clockwise direction, opening a plurality of portholes from the first porthole to the last porthole, reviewing the plurality of review papers present in the plurality of portholes, making a last cell in the last porthole empty and putting a plurality of new review papers in the first porthole.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a diagram illustrating the schematic view of a learning assistant device, according to an embodiment herein.

FIG. 2 illustrates a perspective view of an outer rotating cylinder in a learning assistant device, according to an embodiment herein.

FIG. 3 illustrates a top side view of a learning assistant device, according to an embodiment herein.

FIG. 4 illustrates a flow chart indicating a method for learning a subject matter using the learning assistant device, according to an embodiment herein.

FIG. 5 illustrates a flow chart indicating a learning plan in a learning assistant device, according to an embodiment of herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a device for assisting a learner for learning a subject matter. According to an embodiment herein, the device comprises an inner rotating cylinder. The inner rotating cylinder further comprises at least two co-axial and concentric cylinders of same altitude and different diameters. The device further comprises an outer rotating cylinder adapted to embrace the inner rotating cylinder. A plurality of vanes is arranged between the two co-axial and concentric inner and outer cylinders for creating a plurality of cells equal to a number of days in a learning plan. A plurality of review papers containing a plurality of subject matters are placed in the plurality of cells and a plurality of portholes equal to a number of review stages in the learning plan is located on the outer rotating cylinder in parallel to the plurality of cells. The device enables the learner to review the plurality of subject matters by opening the plurality of portholes until the end of the learning plan for learning the plurality of subject matters is reached.

According to an embodiment herein, the device further comprises a gear system placed between the inner rotating cylinder and outer rotating cylinder for dividing an entire peripheral surface of the outer rotating cylinder into a predetermined number of port holes corresponding to the predetermined number of the plurality of cells in the inner rotating cylinder.

According to an embodiment herein, the gear system is a serrated gear adapted to get locked such that the outer rotating cylinder is moved rotatably along the inner rotating cylinder at a rate of one cell in a day.

According to an embodiment herein, a diameter of the outer rotating cylinder is more than a diameter of the inner rotating cylinder.

According to an embodiment herein, the number of days in the learning plan is at least 32.

According to an embodiment herein, the number of review stages among the plurality of days in the learning plan is at least 6.

According to an embodiment herein, each review stage is set at a distance making a geometric progression of 2 from a first review day to a last review day.

According to an embodiment herein, the bottom space between the two co-axial and concentric cylinders is covered to hold the plurality of review papers in place.

According to an embodiment herein, the dimensions of the plurality of portholes and the plurality of cells located are same.

According to an embodiment herein, the device further comprises a joining means for joining the inner rotating cylinder with the outer rotating cylinder at a joint axis point for rotating the cylinders with respect to each other.

According to an embodiment herein, the top surface of outer rotating cylinder is covered.

According to an embodiment herein, the plurality of portholes is arranged in such a manner that the last porthole immediately precedes the first porthole.

According to an embodiment herein, the review paper is of a predetermined color for simulating a visual sense for transferring the subject matter to enter into working memory of the learner.

According to one embodiment herein, a method for assisting a learner for learning a plurality of subject matters is provided. According to an embodiment herein, the method comprising the steps of defining a learning plan having a pre-defined number of learning days and review stages, opening a plurality of portholes present on an outer rotating cylinder, placing a plurality of review papers containing the plurality of subject matters in a cell below the first porthole and reviewing the plurality of subject matters. The method enables the learner to learn the plurality of subject matters by reviewing a subject matter on the day defined in each review stage until the end of the learning plan.

According to an embodiment herein, the step of reviewing the plurality of subject matters further comprises turning the outer rotating cylinder along a cell in a clockwise direction, opening a plurality of portholes from the first porthole to the last porthole, reviewing the plurality of review papers present in the plurality of portholes, making a last cell the last porthole empty and putting a plurality of new review papers in the first porthole.

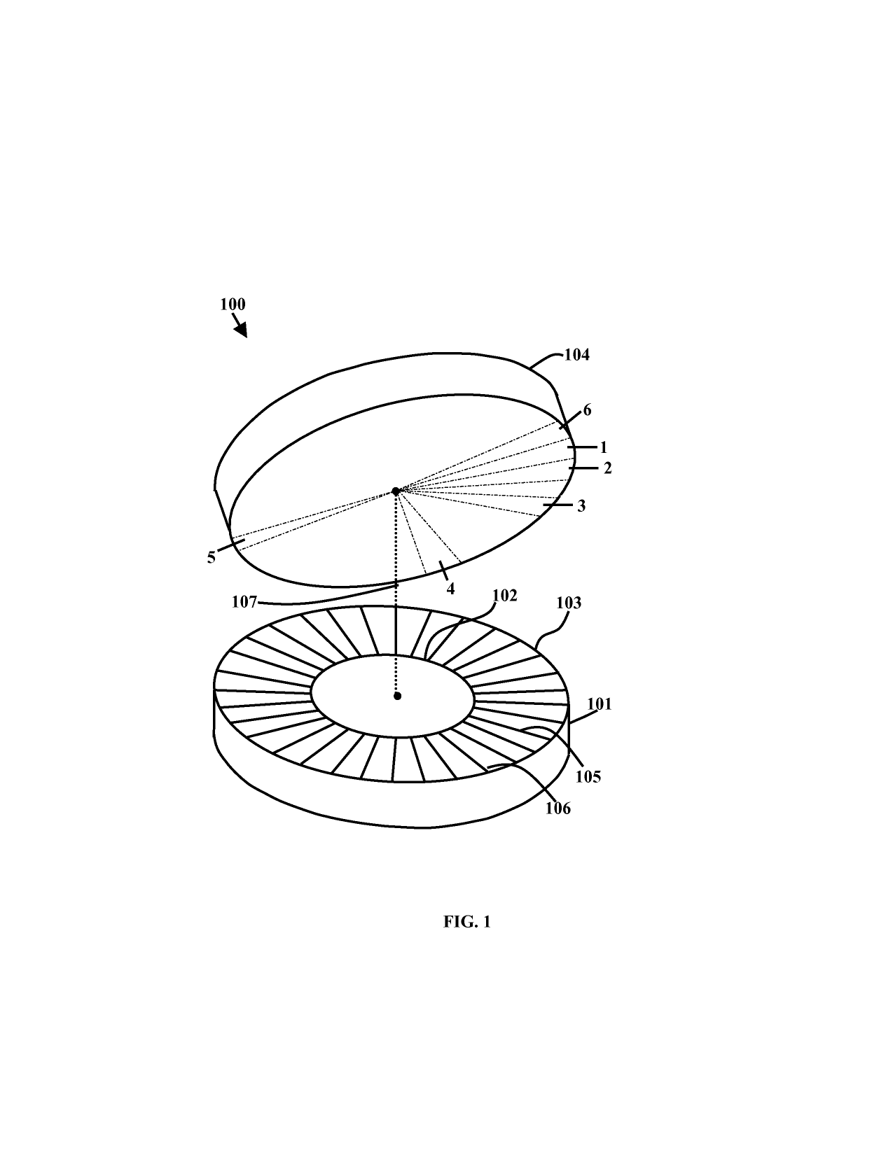

FIG. 1 is a diagram illustrating the schematic view of a learning assistant device according to an embodiment herein. The device 100 comprises an inner rotating cylinder 101. The inner rotating cylinder further comprises at least two co-axial and concentric cylinders 102 and 103 of same altitude and different diameter. The device further comprises an outer rotating cylinder 104 adapted to embrace the inner rotating cylinder, a plurality of vanes 105 between the two co-axial and concentric cylinders 102 and 103 for creating a plurality of cells 106 equal to a number of days in a learning plan, a plurality of review papers (not shown figure) containing a plurality of subject matters placed in the plurality of cells 106 and a plurality of portholes 1-6 equal to a number of review stages in the learning plan located on the outer rotating cylinder parallel to the plurality of cells 106. The device 100 enables the learner to review the plurality of subject matters by opening the plurality of portholes 1-6, until the end of the learning plan for learning the plurality of subject matters. The device 100 further comprises a gear system placed between the inner rotating cylinder 101 and outer rotating cylinder for dividing an entire peripheral surface of the outer rotating cylinder 104 into a predetermined number of port holes 1-6 corresponding to the predetermined number of plurality of cells 106 in the inner rotating cylinder 101. The gear system is a serrated gear adapted to get locked such that the outer rotating cylinder 104 moves rotationally along the inner rotating cylinder 101 at a rate of one cell in a day. A diameter of the outer rotating cylinder 104 is more than a diameter of the inner rotating cylinder. Each review stage is set at a distance making a geometric progression of two from a first review day to a last review day. The bottom of the space between the two co-axial and concentric cylinders is covered to hold the plurality of review papers in place. The dimensions of the plurality of portholes and the plurality of cells located are same.

The device 100 further comprises a joining means 107 for joining the inner rotating cylinder 101 with the outer rotating cylinder 104 at a joint axis point for the cylinders to spin on each other. The top surface of outer rotating cylinder is covered. The plurality of portholes 1-6 is arranged in a manner that the last porthole 6 immediately precedes the first porthole 1.

According to FIG. 1, the porthole 1 is an input part of the instrument and corresponds to a first review stage of a plurality of review papers. The porthole 2 is arranged for a second review stage of the plurality of subject matters, after a day since the input of the plurality of the subject matters into the instrument. The porthole 2 is situated in the clockwise direction immediately after the instrument input so that the plurality of review papers put into the instrument input through porthole 1 on previous day are transferred under this porthole after a day to be reviewed.

The porthole 3 is arranged specially for a third review stage of the learning plan, which is done after an elapse of two days since the completion of the second review stage and after an elapse of three days since an input into the instrument. The porthole 3 is located two cells after the porthole 2 in a clockwise direction and three cells after the input of the device. The porthole 3 is located on the location of porthole 2 for the last two days. Thus the porthole 2 situated under porthole 3 is to be reviewed for the second stage of review, after an elapse of two days of review of the second stage of the plurality of review papers, The entries located under porthole 3 have been under porthole 2 for the past two days and are entered into the instrument through porthole 1.

The porthole 4 is arranged for a special fourth stage review of the learning plan performed after an elapse of four days since the completion of a third stage review of the plurality of review papers and totally after an elapse of 7 days since the input of the entries into the instrument. The porthole 4 is located four cells after the porthole 3 and 7 cells after the instrument input. When the outer rotating cylinder is rotated regularly buy a cell length in a clockwise direction, the porthole 4 is located in the location of porthole 3 in the last 4 days. So four days after the third review stage of the plurality of review papers, the plurality of review papers are located under porthole 4 for fourth review stage. The plurality of review papers located under porthole 4 were under porthole 3 four days ago, under porthole 2 six days ago and entered into the instrument through porthole 1 seven days ago.

A porthole 5 is a special review of the plurality of review papers in the fifth stage. The fifth stage review is done after an elapse of eight days since the completion of the fourth stage review of the plurality of review papers and after an elapse of fifteen days since the input of the plurality of the review papers into the instrument. The porthole 5 is located eight cells after the porthole 4 and fifteen cells after an instrument input. After each rotation of a large cap by one cell length in a clockwise direction every day, the porthole 5 is located in the location of porthole 3 in the last 8 days. So after elapse of eight days since the completion of the third stage review of the plurality of review papers, the plurality of review papers are located under porthole 5 for a fifth stage review. The plurality of review papers located under porthole 5 were under porthole 4 for the past eight days, under porthole 3 for the past twelve days, under porthole 2 for the past fourteen days and entered into the instrument through porthole 1 fifteen days ago.

A porthole 6 is arranged specially to perform the sixth stage of the review of entries or the last review stage, which is done after an elapse of 16 days since the completion of the fifth stage review of the entries and totally after an elapse of 31 days since the entering of the entries into the instrument. The porthole 6 is located sixteen cells after the porthole 4 and thirty one cells after the instrument input. After a rotation of the large cap by one cell length in a clockwise direction every day, the porthole 6 will be located in the location of porthole 5 for the past 8 days. So after an elapse of sixteen days since the completion of the third stage review of the entries, which is the last review stage, these entries will be located under porthole 5 for the fifth review stage. The entries are located under porthole 6 were under porthole 4 before eight days, under porthole 4 before twenty four days and under porthole 3 before twenty eight days, under porthole 2 before thirty days and entered into the instrument through porthole 1 before thirty one days. The entries exiting from the porthole 6 are transformed to the long term memory of the learner. The sixth review stage is the last stage. The porthole 6 is considered as the output of the instrument. The entries of the porthole 6 are emptied every day. The porthole 1, which is the first stage porthole of the instrument is located after the porthole 6. Therefore an entry review cycle will be passed again and again and the input of the instrument is always empty. The method is repeated in a 31 days time period.

As the outer rotating cylinder 104 rotates and passes through a distance equal to the length of a cell in a clockwise direction, the porthole 1 is situated in the location of port hole 6 in the previous day, which was totally empty in the previous day. Thus the porthole 1 is always empty and receives the new set of the plurality of review papers.

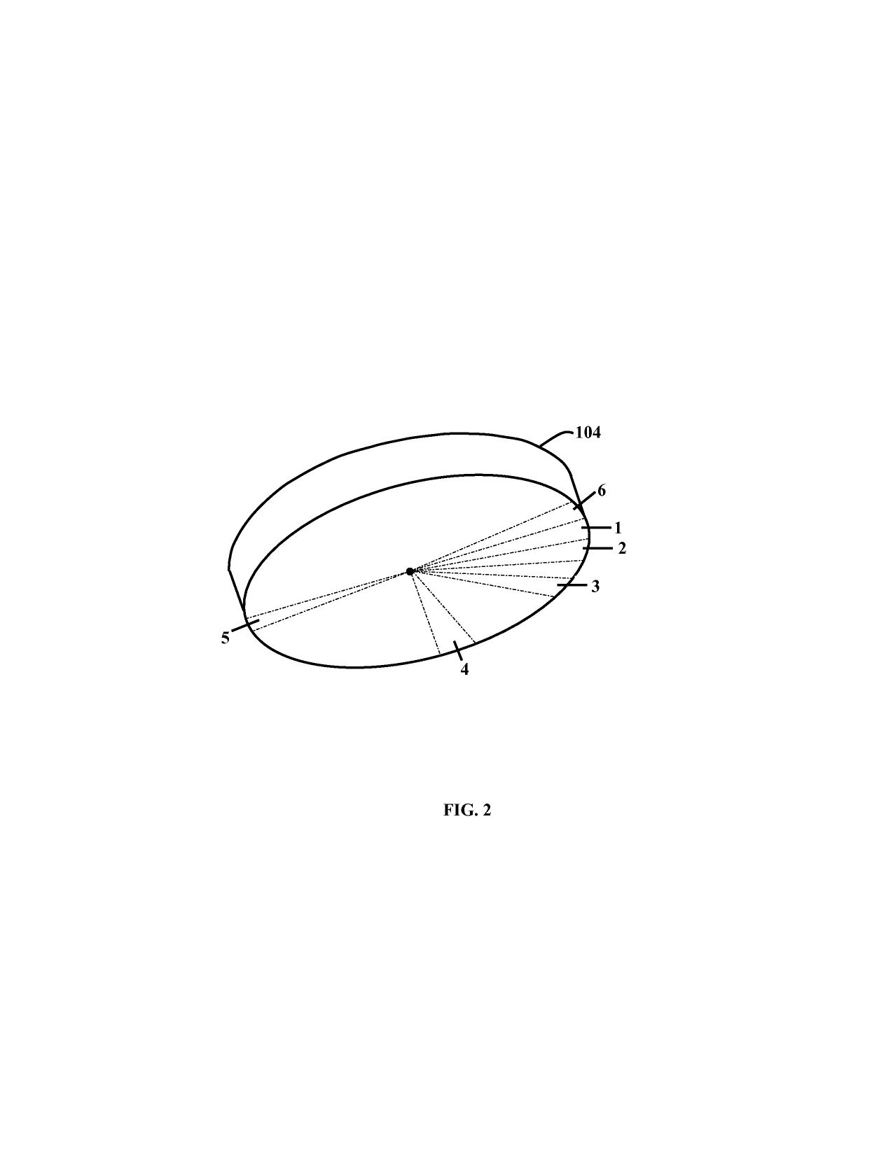

FIG. 2 illustrates a perspective view of an outer rotating cylinder in a learning assistant device, according to an embodiment herein. With respect to FIG. 2, the outer rotating cylinder 104 is located with a plurality of portholes 1-6 which are equal to a number of review stages in the learning plan in parallel to the plurality of cells. The device 100 enables the learner to review the plurality of subject matters by opening the plurality of portholes 1-6 until the end of the learning plan for learning the plurality of subject matters. A diameter of the outer rotating cylinder 104 is more than a diameter of the inner rotating cylinder. Each review stage is set at a distance making a geometric progression of two from a first review day to a last review day. The dimensions of the plurality of portholes 1-6 and the plurality of cells are same. The top surface of outer rotating cylinder is covered. The plurality of portholes is arranged in a manner such that the last porthole 6 immediately precedes the first porthole 1.

As a porthole is opened, a symmetrical cell is observed under the porthole. The plurality of special portholes is review windows. The distance between the first porthole and a next porthole is the same as the distance between review stage specific to that window and the next review stage. Immediately after the last review porthole 6, the first porthole is located. Hence rotational, periodic mode and turning back of the first window to the first mode is included.

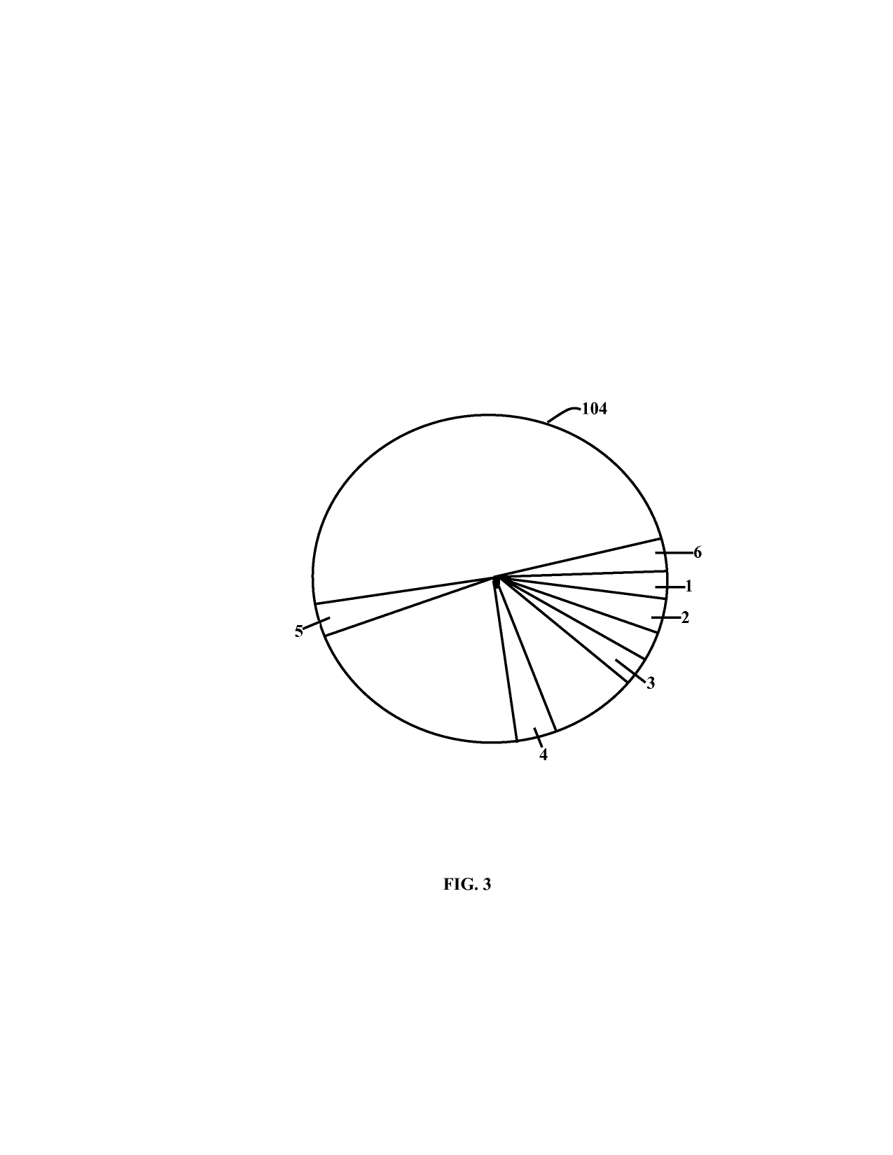

FIG. 3 illustrates a top view of a learning assistant device, according to an embodiment herein. With respect to FIG. 3 a preset number of portholes 1-6 for recalling the review days are contrived on the outer rotating cylinder 104, wherein each of the portholes completely coincide with the cells holding the review papers existing in the inner rotating cylinder. The length and width of the port holes are equal to that of the holes/cells, as each of the portholes opens a symmetrical hole which is observed under the porthole.

According to FIG. 3, a porthole 1 is an input part of the instrument and corresponds to a first stage review of a plurality of review papers. A porthole 2 is specifically arranged to carry out a second stage review of the plurality of subject matters, in a day after the input to the instrument. The porthole 2 is situated in the clockwise direction immediately after the instrument input. So the entries put into the instrument input through porthole 1 in the previous day are transferred to the cell under the porthole a after a day.

A porthole 3 is specially arranged to perform a third stage review of the entries, which is done after an elapse of two days since the completion of the second stage review and after an elapse of three days since the input into the instrument. The porthole 3 is located two cells after the porthole 2 in clockwise direction and three cells after the input of the device. The porthole 3 is located on the location of porthole 2 in the last two days. So porthole 2 is situated under porthole 3 after an elapse of two days since the second stage review of the entries for the third review stage. The entries located under porthole 3 have been under porthole 2 two days ago and entered into the instrument through porthole 1.

The porthole 4 is specially arranged to perform the fourth stage review of the entries, which is done four days after the completion of third stage review of entries and totally after 7 since the input of those entries into the instrument. The porthole 4 is located four cells behind the review porthole 3 and seven cells after the instrument input. After rotating the outer rotating cylinder by one cell-length in a clockwise direction every day, the porthole 4 is located in the location of porthole 3 for the last 4 days. Thus the entries are located under porthole 4 for the fourth stage review after elapse of 4 days since the completion of the third stage review of the entries. The entries which are located currently under porthole 4 were under porthole 3 four days ago, under porthole 2 six days ago and entered into the instrument through porthole 1 seven days ago.

A porthole 5 is specially arranged to perform the fifth stage review of the entries, which is done after an elapse of eight days since the completion of the fourth stage review of the entries and totally after an elapse of 15 days since the input into the instrument. The porthole 5 is located after eight cells from the porthole 4 and fifteen cells since the instrument input. When the large cap is rotated by one cell length in the clockwise direction every day, the porthole 5 is located in the location of porthole 4 for the last eight days. So the input entries will be located under porthole 5 for a fifth stage review after an elapse of eight days since the third stage review of the entries. The entries that are currently located under porthole 5 were under porthole 4 eight days ago, under porthole 3 twelve days ago, under porthole 2 fourteen days ago and entered into the instrument through porthole 1 fifteen days ago.

A porthole 6 is specially arranged to perform the sixth stage review of the entries or the last review stage, which is done after an elapse of sixteen days since the completion of the fifth stage review of the entries and totally after an elapse of thirty one since the input into the instrument. The porthole 6 is located after sixteen holes from porthole 4 and after thirty one cells since an input port. When the large cap is rotated by one cell length every day in clockwise direction, the porthole 6 will be located in the location of porthole 5 for the last eight days. So the input entries will be moved to porthole 6 after an elapse of sixteen days after the fifth stage review of the input entries. The entries are located under porthole 6 were under porthole 5 sixteen days ago, under porthole 4 twenty four days ago and under porthole 3 twenty eight days ago, under porthole 2 thirty days ago and entered into the instrument through porthole 1 thirty one days ago. The entries exiting from the porthole 6 are transformed to the long term memory of the learner. The sixth review stage is the last stage, and the porthole 6 is considered as the output of the instrument. The entries of the porthole 6 are emptied every day. The porthole 1, first stage porthole of the instrument is located after the porthole 6. Therefore entry review cycle will be passed again and again and the input of the instrument is always kept empty. The method is repeated during a 31 days time period.

As the cap rotates and passes through a distance equal to the length of a cell in a clockwise direction, the porthole 1 is situated instead of the previous location of instrument output which was totally empty in the previous day, so always this porthole is empty and always receives the new entries.

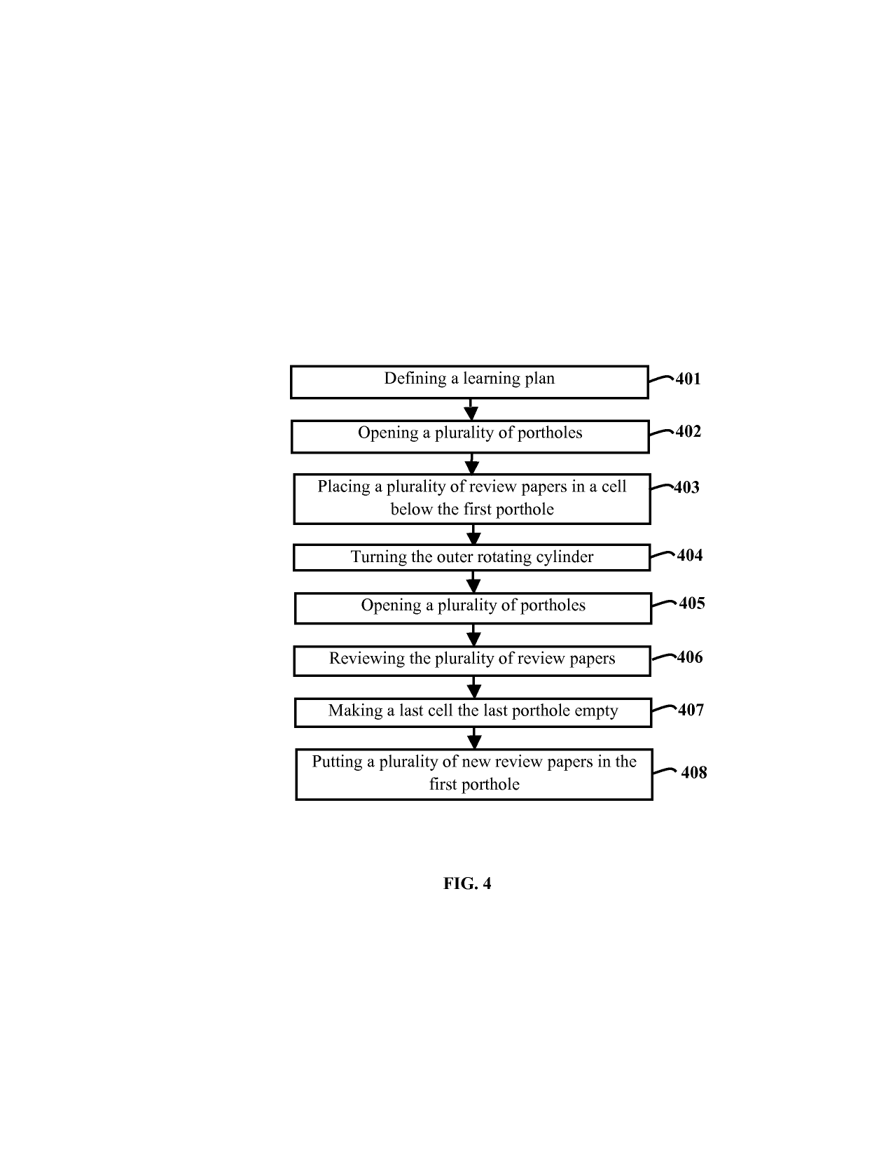

FIG. 4 illustrates a flow chart indicating a method for learning a subject matter using the learning assistant device, according to an embodiment herein. With respect to FIG. 4, the method comprises the steps of defining a learning plan having a pre-defined number of learning days and review stages (401). A plurality of portholes present on an outer rotating cylinder is opened (402). A plurality of review papers containing the plurality of subject matters is placed in a cell arranged below the first porthole (403). The outer rotating cylinder is turned along a cell in a clockwise direction (404). A plurality of portholes ranging from the first porthole to the last porthole is opened to perform a respective stage review of the input entries. The first, second, third, fourth, fifth and sixth port holes are opened to access the respective cells arranged below them to carry out a first stage review, second stage review, third stage review, fourth stage review, fifth stage review and sixth stage review respectively. The first stage review of the input entries is done on the next day since the input. The second stage review of the input entries is done after an elapse of two days since the input. The third stage review of the input entries is done after an elapse of four days since the input. The fourth stage review of the input entries is done after an elapse of eight days day since the input. The fifth stage review of the input entries is done after an elapse of sixteen days since the input. The sixth stage review of the input entries is done after an elapse of thirty two days since the input (405). The plurality of review papers present in the plurality of portholes is reviewed (406). After the review of the plurality of review papers present in the plurality of portholes, a last cell the last porthole is emptied (407). A plurality of new review papers is put into the first porthole and all the six stages of the newly put papers are done as explained above (408). Thus the method enables the learner to learn the plurality of subject matters by reviewing a subject matter on the day defined in each review stage until the end of the learning plan.

The scientific table of a review paper through a plurality of portholes is shown in following table.

| | Name of a porthole | | | | | |
|---|---|---|---|---|---|---|
| | 1 | 2 | 3 | 4 | 5 | 6 |
| The review stage | First | Second | Third | Fourth | Fifth | Sixth |
| | (input) | | | | | (output) |
| The number of cells | 0 | 1 | 2 | 4 | 8 | 16 |
| between this porthole | | | | | | |
| and the previous one | | | | | | |
| Time interval between | 0 | 1 | 2 | 4 | 8 | 16 |
| the review stage | | | | | | |
| and the previous one | | | | | | |
| The number of cells | 0 | 1 | 1 + 2 = 3 | 1 + 2 + | 1 + 2 + 4 + | 1 + 2 + 4 + |
| between the porthole | | | | 4 = 7 | 8 = 15 | 8 + 16 = 31 |
| and the previous one | | | | | | |
| Time interval between | 0 | 1 | 1 + 2 = 3 | 1 + 2 + | 1 + 2 + 4 + | 1 + 2 + 4 + |
| the entry input in | | | | 4 = 7 | 8 = 15 | 8 + 16 = 31 |
| to the device | | | | | | |

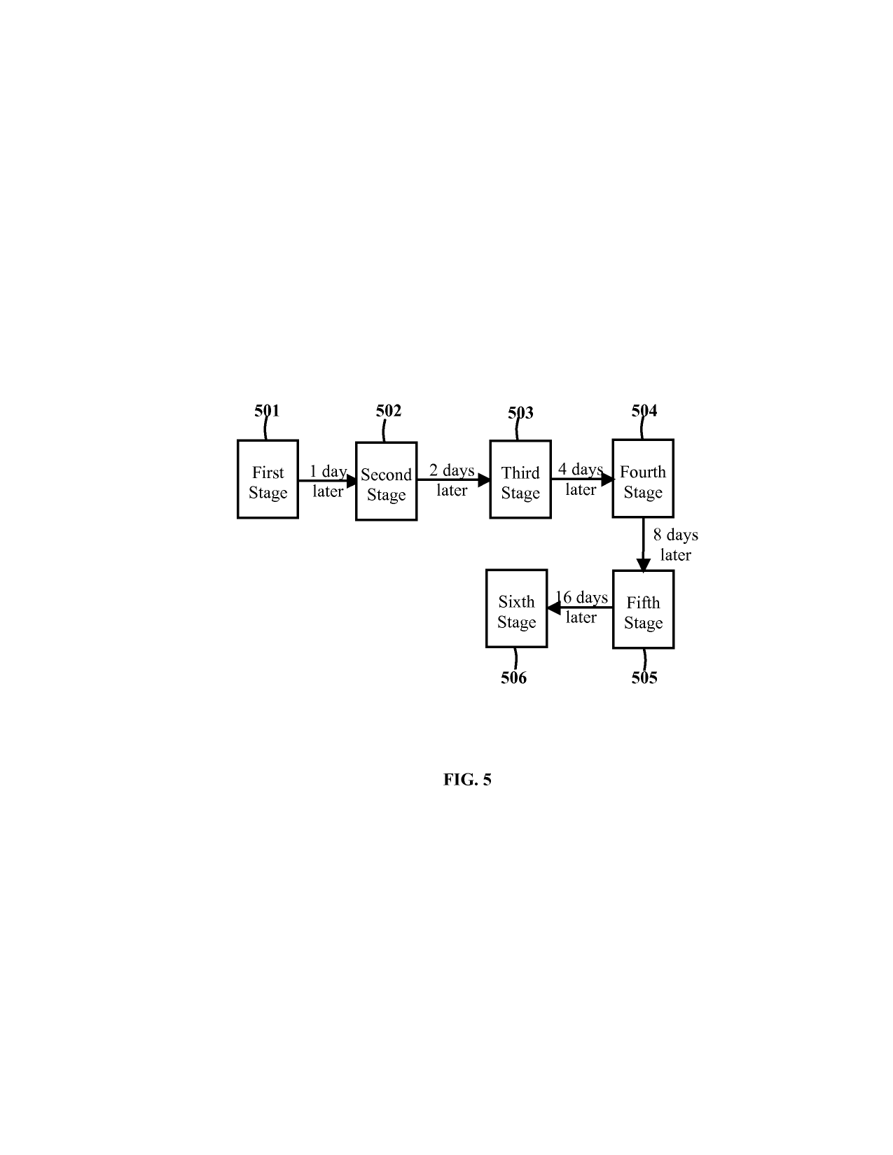

FIG. 5 illustrates a flow chart indicating a learning plan in a learning assistant device, according to an embodiment of herein. With respect to FIG. 5, the number of days in the learning plan is at least 32. The number of review stages among the plurality of days in the learning plan is at least 6. Each review stage is set at a distance making a geometric progression of 2 from a first review day to a last review day. A subject matter to be learned is reviewed based on time intervals in FIG. 5, the subject matter gets transformed to the long term memory of the learner. By the method, the forgetting is avoided.

The important point applied in studying the person is that there is no need to review the subject matter daily with equal time intervals. As the decrease of forgetting slope after each review increases, the interval between the review times increases gradually in a geometric progression manner. Indeed, after each time of review, the related subject matter remains in the memory for a longer time period. The time spent for each time of review will are decreased considerably for the next review, as many of the subject matters are transformed to the long term memory quicker than the other ones and more time is spent for the subject matters which are forgotten quickly. Therefore, the learner will get rid of more repetitions with the highest efficiency and will optimally review the subject matter in necessary cases. Therefore more complex subject matters will automatically be reviewed for more than the others in certain time intervals, till the time the subject matter is memorized thoroughly in the shortest time.

The basis of the device's functioning is purposeful repetition. A human being forgets 75% of what is learnt in 48 hours. The brain forgets received data by increasing and exponential velocity and not by constant and linear velocity, without repletion and other encoding techniques. The person would learn the subject matter for the first time and if the person does not review it for a while, it may be forgotten thoroughly. Indeed the most serious stage of forgetting of a subject matter in the first 24 hours after learning is the first time of learning. After the second learning, the level of recalling the subject matter gets to the initial 100% level, and then it starts getting forgotten with a slope less than the first time. The forgetting slope decreases after each review. After a review of 5 times, the slope gets zero and information is transformed into a long-term memory. The retaining ability of information in the memory decreases considerably over a period of time. It has been found that the repetition of the trained subject matters causes the forgetting curve to become flatter. It has been proved that the time intervals between repetitions of educational subject matters can be increased gradually. And also if there is large time interval between two repetitions, data retrieve may face problems.

The first stage review of the input entries is done on the day of the input (501). The second stage review of the input entries is done after an elapse of a day since the input and after an elapse of a day since the completion of the first stage review (502). The third stage review of the input entries is done after an elapse of three days since the input and after an elapse of two days since the completion of the second stage review (503). The fourth stage review of the input entries is done after an elapse of seven days since the input and after an elapse of four days since the completion of the third stage review (504). The fifth stage review of the input entries is done after an elapse of fifteen days since the input and after an elapse of eight days since the completion of the fourth stage review (505). The sixth stage review of the input entries is done after an elapse of thirty one days since the input and after an elapse of sixteen days since the completion of the fifth stage review (506).

The embodiments herein provide a device and method for a learner for learning a subject matter in the shortest time with a long lasting impact. The device and method helps a learner in revising of a subject matter efficiently and effectively. The device and method makes easy transfer of the plurality of subject matters learnt from a short term memory to a long term memory. The analyzing and digesting of the plurality of subject matters is made easy by the proposed device and method. The device is used for a better improvement of the memory.

The embodiments herein provide a device and method for allotting the correct time intervals for the plurality of subject matters to establish a balance in reviewing a plurality of the subject matters. The device and method is designed in a step by step manner to make a learning process more attractive. The device is simple and tangible. Using the device the learner need not recognize the date of last revision for a subject matter.

The device and method increases the performance of the learner in the process of learning and the learner to shows more tendency towards implementing the plurality of subject matters using the device. The subject matter is transferred to the long term memory with the highest efficiency.

The embodiments herein provide a device and method to prevent memory loss by improving the memory capacity. The information is transformed into the long term memory through a simple procedure.

The device is portable, inexpensive and light. The device doesn't mix the subject matters of different days. Further the device is capable of using the consequences of review and learning principles, without any need to know the quality of the principles by the learner. The device creates an interest in the user in the process of review and learning in a way thereby turning the learning process into an interesting game. The staging learning and reviewing process consequently involves the learner's ambitiousness for improving to higher stages and increasing the review efficiency. The tool is intelligent and is capable of defining the time required for reviewing and learning the subject matters and dividing the time in terms of the subject matters according to the need. The learner is provided with the materials which are learned more, less than those which are learned less. Therefore the subject matter would not exit from the tool till learned. The device determines the learner's dangerous border of forgetting and makes the user review the most on that border.

The proposed learning assistant leads to increase the learning capacity of an individual through a controlled study, a set of encoding, storing and retrieving procedures occur in the learner's brain. Due to the memory failure, for example, amnesia is the result of damage to one of the learning processes, the user can reduce a forgetting level into zero by applying the scientific principles used in the device. The device provides a proper schedule for repeating/revising the studied materials and for understanding the subject matters in which the learner has difficulty. Further the device provides an on-time omission of the learned subject matters and facilitates an enhanced focus on the subject matters not learned yet.

The learning assistant device is considered as an intellectual exercise which helps brain development as well as enhancing the recalling ability. The working memory improves the memory capacity and prevents a memory loss. The learning assistant device is a training aid designed based on scientific theories and educational and psychological experiments. The subject matters are learned quickly and the learner enjoys reading and revising through a scientific repetition of the materials. The device is very simple and is operated easily. Even the device is used for the students, at low levels of education. For getting used to do something/work there are three demanding characteristics such as knowledge, the skill, and tendency. The device provides knowledge, operating skill and tendency for the learner to turn the process of studying into an interesting game.

Knowledge: The device acts based on all of the principles of memory, review and learning. The device inspires the learner with the best method of learning and knowledge.

Operating Skill: Operating skills of study means determining the time needed for studying the lessons smartly by the instrument. If a learner knows a subject matter more, the learner is provided with less review times for that subject matter. The subject matter gets to the output of the instrument sooner and exits faster. If there is a less known subject matter, the learner is provided with more review time. The instrument eliminates the review of the materials at each time of study. The instrument makes the learner to review and repeat the subject matter until definite learning.

Tendency: Balance is the main essence of the learning assistant device. The device prevents the user from excessive study of the learned subject matter and prevents the subject matter from exiting the instrument before being definitely recorded in a long-term memory. The learner learns to review the lessons on-time. The learner's efficiency increases and with satisfactory feeling the response gets reinforced. The device provides a motivation for completing the certain learning process and prevents the study process from being left incompletely. The studying turns into a competition and the learner becomes eager to study the subject matters up to the last stage. Learning and studying are closely interrelated and certain learning demands dynamic study.

Although the embodiments herein are described with various specific embodiments, it will be obvious for a person skilled in the art to practice the embodiments herein with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A device for assisting a learner for learning a subject matter, the device comprising:
an inner rotating cylinder, wherein the inner rotating cylinder comprises at least two co-axial and concentric cylinders of same altitude and different diameter;
an outer rotating cylinder adapted to embrace the inner rotating cylinder;
a plurality of vanes arranged between the two co-axial and concentric cylinders in the inner rotating cylinder for creating a plurality of cells, and wherein a number of the plurality of cells is equal to a number of days in a learning plan;
a plurality of review papers containing a plurality of subject matters placed in the plurality of cells; and
a plurality of portholes located on the outer rotating cylinder parallel to the plurality of cells, and wherein a number of the plurality of portholes is equal to a number of review stages in the learning plan;
wherein the device enables the learner to review the plurality of subject matters by opening the plurality of portholes until the end of the learning plan for learning the plurality of subject matters is reached.

2. The device of claim 1, further comprising a gear system, and wherein the gear system is placed between the inner rotating cylinder and outer rotating cylinder for dividing a full round rotation of the outer rotating cylinder into a determined number of the plurality of cells in the inner rotating cylinder.

3. The device of claim 2, wherein the gear system is a serrated gear adapted to get locked such that the outer rotating cylinder moves rotationally along the inner rotating cylinder at a rate of one cell in a day.

4. The device of claim 1, wherein a diameter of the outer rotating cylinder is more than a diameter of the inner rotating cylinder.

5. The system of claim 1, wherein the numbers of days in the learning plan is at least 32.

6. The system of claim 1, wherein the number of review stages among the plurality of days in the learning plan is at least 6.

7. The system of claim 1, wherein a time interval between two successive review stages is set such that the time interval is arranged to follow a geometric progression of 2 from a first review day to a last review day.

8. The device of claim 1, wherein a bottom space between the two co-axial and concentric cylinders is covered to hold a plurality of review papers in place.

9. The device of claim 1, wherein the dimensions of the plurality of portholes and the plurality of cells are same.

10. The device of claim 1, further comprising a joining means for joining the inner rotating cylinder with the outer rotating cylinder at a joint axis point for the cylinders to spin on each other.

11. The device of claim 1, wherein the top surface of outer rotating cylinder is covered.

12. The device of claim 1, wherein the plurality of portholes are arranged in such a manner that the last porthole immediately precedes the first porthole.

13. The device of claim 1, wherein the review paper is of a predetermined color for simulating a visual sense for making the subject matter to enter into a working memory of the learner.

14. A method for assisting a learner for learning a plurality of subject matters, the method comprising steps of:
defining a learning plan having a pre-defined number of learning days and review stages;
opening a plurality of portholes present on a outer rotating cylinder;
placing a plurality of review papers containing the plurality of subject matters in a cell below the first porthole; and
reviewing the plurality of subject matters;
wherein the method enables the learner to learn the plurality of subject matters by reviewing a subject matter on the day defined in each review stage until the end of the learning plan is achieved

15. The method of claim 14, wherein the step of reviewing the plurality of subject matters further comprises:
turning the outer rotating cylinder along a cell in a clockwise direction;
opening a plurality of portholes from the first porthole to the last porthole;
reviewing the plurality of review papers present in the plurality of portholes;
making a last cell the last porthole empty; and
putting a plurality of new review papers in the first porthole;
